(19) United States
(12) Patent Application Publication
(10) Pub. No.: US 2022/0026143 A1
(43) Pub. Date: Jan. 27, 2022

(54) STAND-ALONE BEVERAGE DISPENSER AND COOLING SYSTEM

(71) Applicant: Haier US Appliance Solutions, Inc., Wilmington, DE (US)

(72) Inventors: Daniel Roth, Indianapolis, IN (US); Brent Alden Junge, Evansville, IN (US); Richard Devos, Goshen, KY (US); Gregory Scott Carr, Louisville, KY (US); Danister Abeygunawardana, Jeffersonville, IN (US)

(21) Appl. No.: 16/934,124

(22) Filed: Jul. 21, 2020

(51) Int. Cl. F25D 31/00; C02F 1/00; F25D 13/00

(52) U.S. Cl. CPC F25D 31/002; F25D 13/00; C02F 1/001

(57) ABSTRACT

A beverage cooling system includes a first tub, a second tub nested within the first tub to define a first space therebetween for receiving a heat transfer material. A tube passes through the first space, is in thermal communication with the heat transfer material, and is configured for receiving a beverage. In operation, the second tub may be filled with ice or another cool material such that the beverage passing through the tube, which is in thermal communication with the heat transfer material and the ice, may be chilled before being dispensed to a user.

### FIELD OF THE INVENTION

The present subject matter relates generally to beverage dispensers, and more particularly to a stand-alone beverage dispenser for cooling and dispensing a beverage.

### BACKGROUND OF THE INVENTION

Beverage dispensers are commonly used with a variety of consumer and commercial appliances to dispense various beverages to consumers, such as cold water, for example. These beverage dispensers typically receive a consumable beverage from a source, such as a municipal water supply or a bottle of the beverage, cool the beverage, and dispense the beverage out through an outlet of the dispenser for end use.

For example, beverage dispensers, including stand-alone water coolers/dispensers, receive room temperature water for consumption and cool the water to a desired temperature prior to dispensing and consumption. In order to provide chilled beverages, beverage dispensers generally chill small volumes of liquid (e.g., between eight and sixteen ounces) to be dispensed for each beverage using a sealed refrigeration system. To permit consecutive preparation of beverages and decrease preparation time, certain beverage dispensers include a removable water storage reservoir holding enough water to dispense between four and eight single-serve beverages and keep the reservoir is a chilled state using the refrigeration system.

However, certain drawbacks exist. For example, sealed refrigeration systems include multiple components, add costs, and increase the likelihood of a system/component failure. In addition, when a beverage is stored in a reservoir for cold storage, the refrigeration cycle must be carefully maintained in order to prevent freezing of the stored beverage. Additionally or alternatively, the refrigeration cycle must be run frequently to maintain the stored beverage at the desired temperature, consuming large amounts of electricity and energy. Further, when the reservoir is depleted, a large amount of time may be required to refill and rechill the tank.

Accordingly, a stand-alone beverage dispenser that obviates one or more of the above mentioned deficiencies would be desirable. For instance, a beverage dispenser that provides a large supply of cold water on demand would be desirable.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a beverage cooling system is provided. The beverage cooling system may include a first tub, a second tub nested within the first tub to define a first space therebetween for receiving a heat transfer material, and a tube passing through the first space. The tube may be in thermal communication with the heat transfer material and may be configured for receiving a beverage.

In another exemplary aspect of the present disclosure, a beverage cooling system is provided. The beverage cooling system may include a first tub, a second tub nested within the first tub to define a first space between the first tub and the second tub, the second tub being configured to store ice to cool the beverage, a beverage provided in the first space, and a recirculation system in fluid communication with the second tub. The recirculation system may include a recirculation line having a first end fluidly connected to the outlet opening of the second tub and a second end fluidly connected to the ice maker, a filter in fluid communication with the recirculation line, and a recirculation pump in fluid communication with the recirculation line, the recirculation pump configured to pump melt water from the second tub to the ice maker.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a stand-alone beverage appliance according to exemplary embodiments of the present disclosure.

FIG. 2 provides a perspective sectional view of a stand-alone beverage appliance according to exemplary embodiments of the present disclosure.

FIG. 3 provides a rear perspective view (with a casing removed) of a stand-alone beverage appliance according to exemplary embodiments of the present disclosure.

FIG. 4 provides a perspective view of a beverage dispenser according to exemplary embodiments of the present disclosure.

FIG. 5 provides a perspective view of a tub assembly according to exemplary embodiments of the present disclosure.

FIG. 6 provides an exploded perspective view of the exemplary tub assembly of FIG. 5 according to exemplary embodiments of the present disclosure.

FIG. 7 provides an exploded perspective view of a tub assembly including a beverage tube according to exemplary embodiments of the present disclosure.

FIG. 8 provides a perspective view of the exemplary beverage tube of FIG. 7 according to exemplary embodiments of the present disclosure.

FIG. 9 provides an exploded view of a first tub and a second tub of the exemplary tub assembly of FIG. 5 according to exemplary embodiments of the present disclosure.

FIG. 10 provides a side cut-away view of a tub assembly including a valve according to exemplary embodiments of the present disclosure.

FIG. 11 provides a schematic view of a recirculation system according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

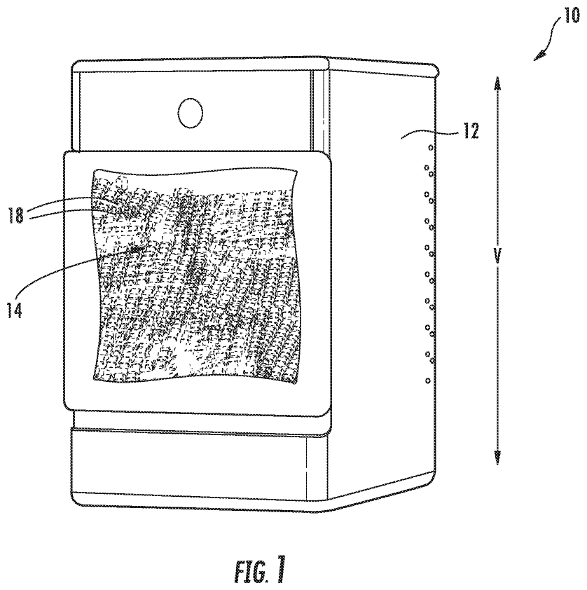

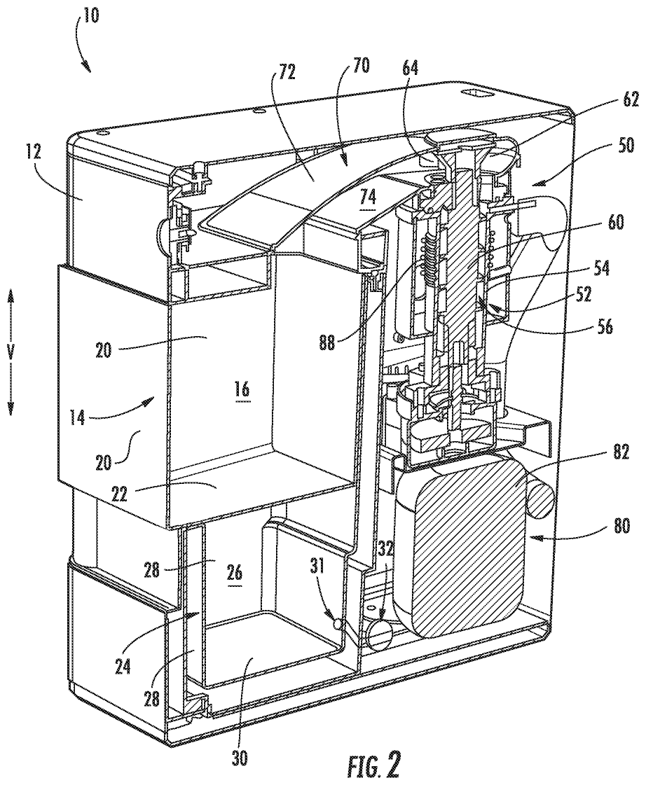

Referring now to FIG. 1, one embodiment of a stand-alone ice making appliance 10 in accordance with the present disclosure is illustrated. As shown, appliance 10 includes an outer casing 12 which generally at least partially houses various other components of the appliance therein 10. A container 14 is also illustrated. Container 14 defines a first storage volume 16 for the receipt and storage of ice 18 therein. A user of the appliance 10 may access ice 18 within the container 14 for consumption or other uses. Container 14 may include one or more sidewalls 20 and a base wall 22 (see FIG. 2), which may together define the first storage volume 16. In exemplary embodiments, at least one sidewall 20 may be formed from a clear, see-through (i.e. transparent or translucent) material, such as a clear glass or plastic, such that a user can see into the first storage volume 16 and thus view ice 18 therein. Further, in exemplary embodiments, container 14 may be removable, such as from the outer casing 12, by a user. This facilitates easy access by the user to ice within the container 14 and further, for example, may provide access to a water tank 24 (see FIG. 2) of the appliance 10.

Appliances 10 in accordance with the present disclosure may be stand-alone appliances, and thus may not be connected to refrigerators or other appliances. Additionally or alternatively, in exemplary embodiments, such appliances may or may not be connected to plumbing or another water source that is external to the appliance 10, such as a refrigerator water source. In some exemplary embodiments, water may be supplied to the appliance 10 manually by a user, such as by pouring water into water tank 24.

Notably, appliances 10 as discussed herein may include various features which allow the appliance 10 to be affordable and desirable to typical consumers. For example, the stand-alone feature may reduce the cost associated with the appliance 10 and allow the consumer to position the appliance 10 at any suitable desired location. In some embodiments, the only requirement for operation of ice making appliance 10 may be access to an electrical source. The container 14, which may be fixed to or removable from the appliance 10, allows easy access to ice and allows the container 14 to be moved to a different position from the remainder of the appliance 10 for ice usage purposes. Additionally, in exemplary embodiments as discussed herein, appliance 10 is configured to make nugget ice (as discussed herein) which is becoming increasingly popular with consumers.

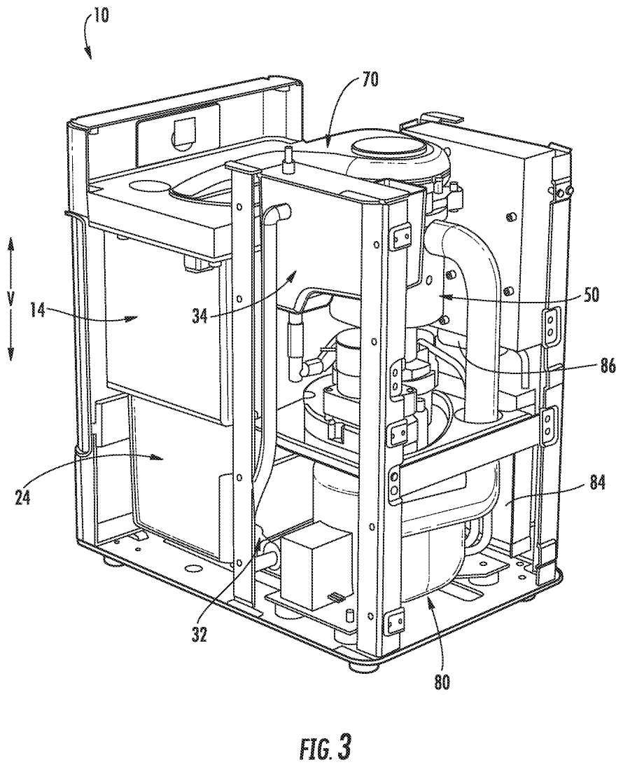

Referring to FIGS. 2 and 3, various other components of appliances 10 in accordance with the present disclosure are illustrated. For example, as mentioned, appliance 10 may include a water tank 24. The water tank 24 may define a second storage volume 26 for the receipt and holding of water. Water tank 24 may include one or more sidewalls 28 and a base wall 30 which may together define the second storage volume 26. In exemplary embodiments, the water tank 24 may be disposed below the container 14 along a vertical direction V defined for the appliance 10, as shown. In some exemplary embodiments, water tank 24 may receive and store melt water from ice 18 that has melted while in container 14.

As discussed, in exemplary embodiments, water may be provided to the water tank 24 for use in forming ice. Accordingly, appliance 10 may further include a pump 32. Pump 32 may be in fluid communication with the second storage volume 26. For example, water may be flowable from the second storage volume 26 through an opening 31 defined in the water tank 24, such as in a sidewall 28 thereof, and may flow through a conduit to and through pump 32. Pump 32 may, when activated, actively flow water from the second storage volume 26 therethrough and from the pump 32.

Water actively flowed from the pump 32 may be flowed (for example through a suitable conduit) to a reservoir 34. For example, reservoir 34 may define a third storage volume 36, which may be defined by one or more sidewalls 38 and a base wall 40. Third storage volume 36 may, for example, be in fluid communication with the pump 32 and may thus receive water that is actively flowed from the water tank 24, such as through the pump 32. For example, water may be flowed into the third storage volume 36 through an opening 42 defined in the reservoir 34.

Reservoir 34 and third storage volume 36 thereof may receive and contain water to be provided to an ice maker 50 for the production of ice. Accordingly, third storage volume 36 may be in fluid communication with ice maker 50. For example, water may be flowed, such as through opening 44 and through suitable conduits, from third storage volume 36 to ice maker 50. A filter 194 (FIG. 11) may be provided in fluid communication with the third storage volume 36 and the ice maker 50. The filter 194 may filter water as it is flowed from the third storage volume 36 to the ice maker 50.

Ice maker 50 generally receives water, such as from reservoir 34, and freezes the water to form ice 18. While any suitable style of ice maker is within the scope and spirit of the present disclosure, in exemplary embodiments, ice maker 50 is a nugget ice maker, and in particular is an auger-style ice maker. As shown, ice maker 50 may include a casing 52 into which water from third storage volume 36 is flowed. Casing 52 is thus in fluid communication with third storage volume 36. For example, casing 52 may include one or more sidewalls 54 which may define an interior volume 56, and an opening 58 may be defined in a sidewall 54. Water may be flowed from third storage volume 36 through the opening 58 (such as via a suitable conduit) into the interior volume 56.

As illustrated, an auger 60 may be disposed at least partially within the casing 52. During operation, the auger 60 may rotate. Water within the casing 52 may at least partially freeze due to heat exchange, such as with a refrigeration system as discussed herein. The at least partially frozen water may be lifted by the auger 60 from casing 52. Further, in exemplary embodiments, the at least partially frozen water may be directed by auger 60 to and through an extruder 62. The extruder 62 may extrude the at least partially frozen water to form ice, such as nuggets of ice 18.

Formed ice 18 may be provided by the ice maker 50 to container 14 and may be received in the first storage volume 16 thereof. For example, ice 18 formed by auger 60 and/or extruder 62 may be provide to the container 14. In exemplary embodiments, appliance 10 may include a chute 70 for directing ice 18 produced by the ice maker 50 towards the first storage volume 16. For example, as shown, chute 70 is generally positioned above container 14 along the vertical direction V. Thus, ice can slide off of chute 70 and drop into storage volume 16 of container 14. Chute 70 may, as shown, extend between ice maker 50 and container 14, and may include a body 72 which defines a passage 74 therethrough. Ice 18 may be directed from the ice maker 50 (such as from the auger 60 and/or extruder 62) through the passage 74 to the container 14. In some embodiments, for example, a sweep 64, which may for example be connected to and rotate with the auger, may contact the ice emerging through the extruder 62 from the auger 60 and direct the ice through the passage 74 to the container 14.

As discussed, water within the casing 52 may at least partially freeze due to heat exchange, such as with a refrigeration system. In exemplary embodiments, ice maker 50 may include a sealed refrigeration system 80. The sealed refrigeration system 80 may be in thermal communication with the casing 52 to remove heat from the casing 52 and interior volume 56 thereof, thus facilitating freezing of water therein to form ice. Sealed refrigeration system 80 may, for example, include a compressor 82, a condenser 84, a throttling device 86 and an evaporator 88. Evaporator 88 may, for example, be in thermal communication with the casing 52 in order to remove heat from the interior volume 56 and water therein during operation of sealed system 80. For example, evaporator 88 may at least partially surround the casing 52. In particular, evaporator 88 may be a conduit coiled around and in contact with casing 52, such as the sidewall(s) 54 thereof. During operation of sealed system 80, refrigerant exits evaporator 88 as a fluid in the form of a superheated vapor and/or vapor mixture. Upon exiting evaporator 88, the refrigerant enters compressor 82 wherein the pressure and temperature of the refrigerant are increased such that the refrigerant becomes a superheated vapor. The superheated vapor from compressor 82 enters condenser 84 wherein energy is transferred therefrom and condenses into a saturated liquid and/or liquid vapor mixture. This fluid exits condenser 84 and travels through throttling device 86 that is configured for regulating a flow rate of refrigerant therethrough. Upon exiting throttling device 86, the pressure and temperature of the refrigerant drop at which time the refrigerant enters evaporator 88 and the cycle repeats itself. In certain embodiments, throttling device 86 may be a capillary tube. Notably, in some embodiments, sealed system 80 may additionally include fans (not shown) for facilitating heat transfer to/from the condenser 84 and evaporator 88.

As discussed, in exemplary embodiments, ice 18 may be nugget ice. Nugget ice is ice that that is maintained or stored (i.e. in first storage volume 16 of container 14) at a temperature greater than the melting point of water or greater than about thirty-two degrees Fahrenheit. Accordingly, the ambient temperature of the environment surrounding the container 14 may be at a temperature greater than the melting point of water or greater than about thirty-two degrees Fahrenheit. In some embodiments, such temperature may be greater than forty degrees Fahrenheit.

Ice 18 held within the first storage volume 16 may gradually melt. The melting speed is increased for nugget ice due to the increased maintenance/storage temperature. Accordingly, drain features may advantageously be provided in the container for draining such melt water. Additionally, and advantageously, the melt water may in exemplary embodiments be reused by appliance 10 to form ice.

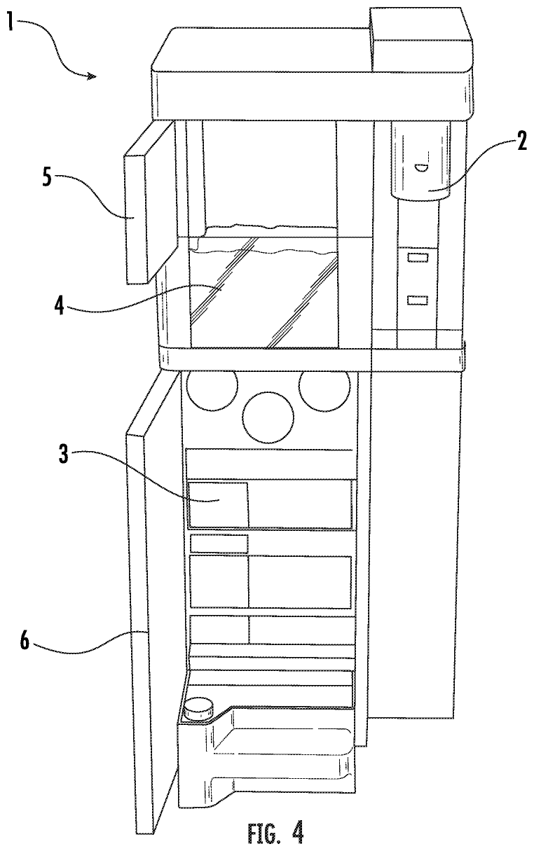

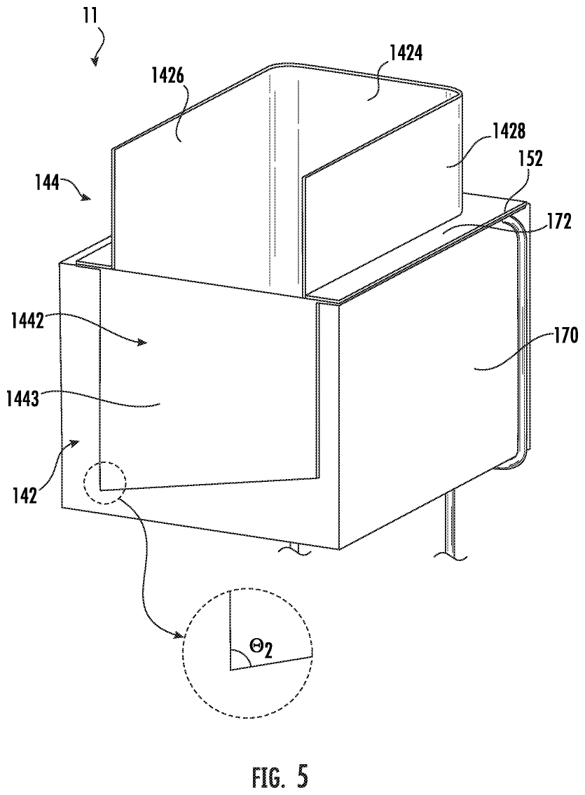

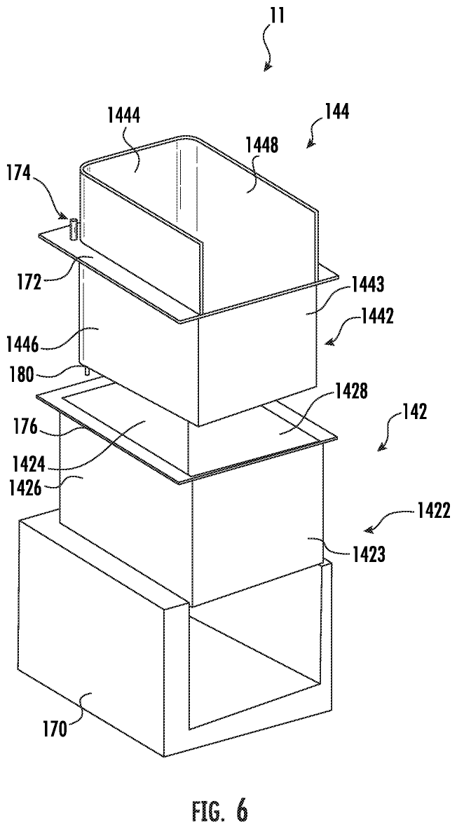

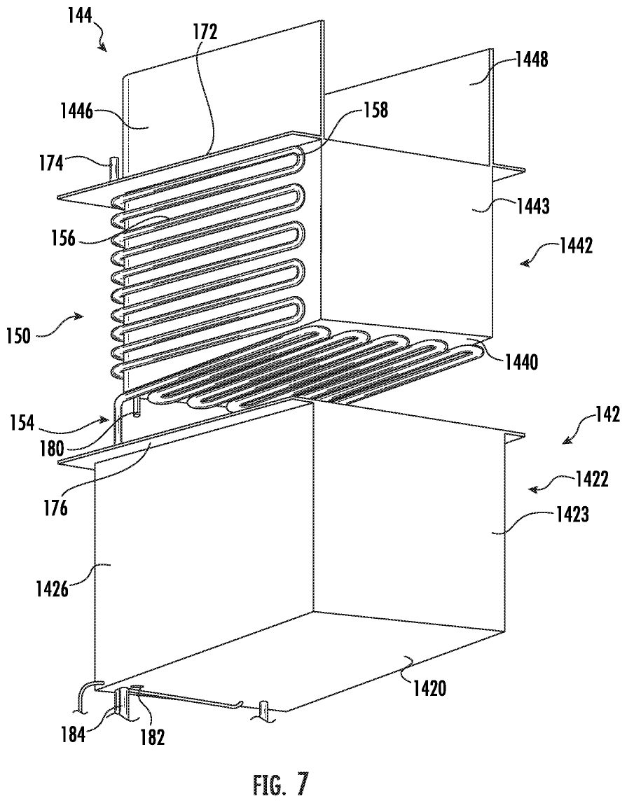

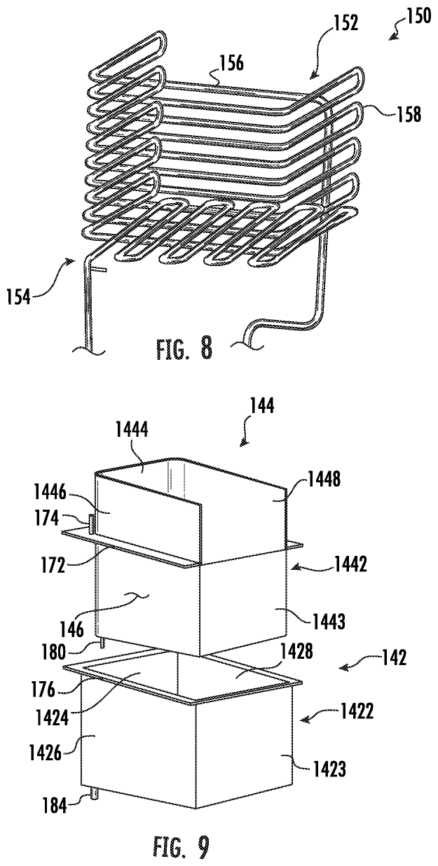

FIG. 4 illustrates an example of a beverage dispenser 1 which incorporates an ice making appliance (e.g., stand-alone ice making appliance 10) and a beverage cooling system 11 described hereinafter. Beverage dispenser 1 may include an ice making appliance (e.g., stand-alone ice making appliance 10), a dispenser nozzle 2, a beverage container compartment 3, ice container 4 (e.g., container 14), and a beverage cooling system 11 (described below with reference to FIGS. 5 through 10). The beverage container compartment 3 may be configured to accommodate a container (e.g., a bottle or canister) containing a beverage (e.g., water or juice) that a user wishes to cool and dispense through the dispenser nozzle 2. The beverage container compartment 3 may be located below the ice container 4 (e.g., container 14) and may include a door 6 through which a user may access the beverage container compartment 3. The ice container 4 may include a door 5 which may be opened and closed to allow access to the ice container 4. Accordingly, a single unit may be used to produce ice, store ice, quick cool a beverage, and dispense the beverage to a user. Hereinafter, a description of the beverage cooling system 11 will be described.

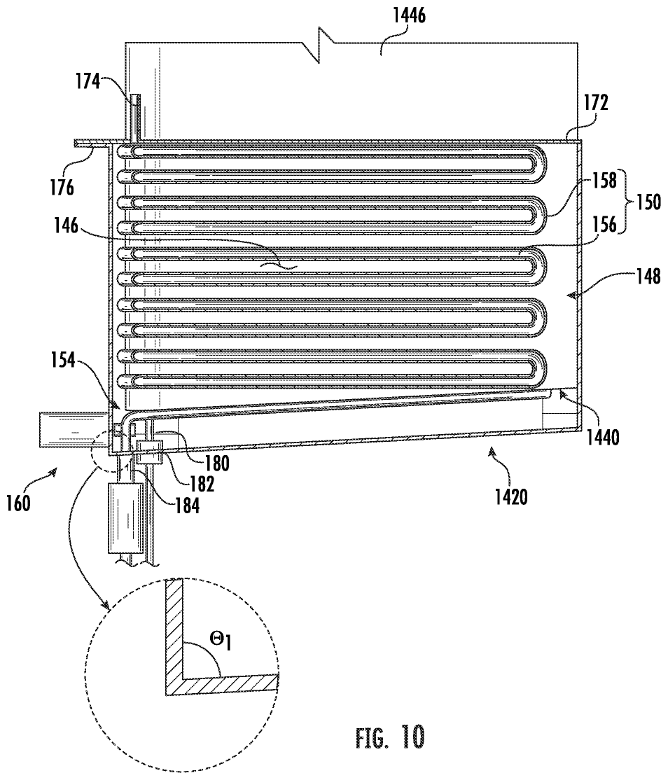

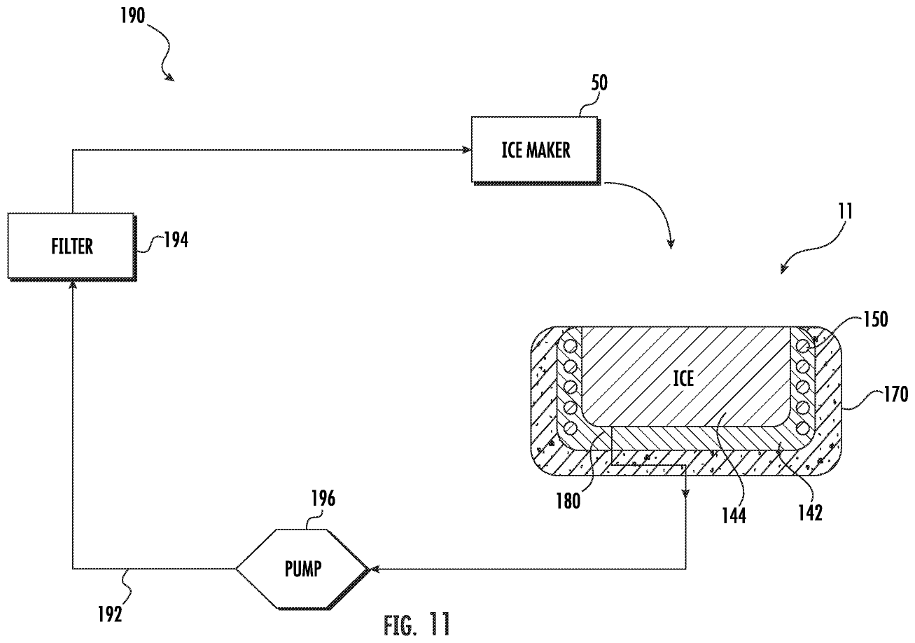

FIGS. 5 through 10 illustrate a beverage cooling system 11 according to an exemplary embodiment of appliance 10. It should be noted that the beverage cooling system 11 described hereinafter may be used in conjunction with or separately from the ice making appliance 10 and/or the beverage dispenser 1 described above. In other words, ice may be separately provided to beverage cooling system 11 without the use of ice making appliance 10. In some embodiments, beverage cooling system 11 may include a first tub 142 and a second tub 144. First tub 142 and second tub 144 may collectively define container 14 in some embodiments. Second tub 144 may be nested within first tub 142. In detail, second tub 144 may be defined by a front panel 1442, a rear panel 1444, a first side panel 1446, a second side panel 1448, and a bottom panel 1440. The bottom panel 1440 may be substantially perpendicular to the front panel 1442, rear panel 1444, first side panel 1446, and third side panel 1448. In some embodiments, the bottom panel 1440 may be angled with respect to a horizontal direction. For example, the bottom panel 1440 may form an acute (e.g., less than 90°) angle (first angle Θ₁, FIG. 10) with the rear panel 1444. Additionally or alternatively, the bottom panel 1440 may form an acute (e.g., less than 90°) angle (second angle Θ₂, FIG. 5) with the first side panel 1446.

In detail, first angle Θ₁ may be between about 75° and about 85°. Similarly, second angle Θ₂ may be between about 75° and about 85°. Accordingly, bottom panel 1440 may be tilted toward the rear of second tub 144 and the first side of second tub 144. When ice that is stored in second tub 144 melts, the drain water may naturally flow toward a first corner defined by the rear panel 1444, first side panel 1446, and bottom panel 1440 due to the angled nature of the bottom panel 1440.

A first space 146 may be defined between the second tub 144 and the first tub 142 when the second tub 144 is nested within the first tub 142. For instance, the first tub 142 may be defined by a front panel 1422, a rear panel 1424, a first side panel 1426, a second side panel 1428, and a bottom panel 1420. When nested, front panel 1422 is spaced apart from front panel 1442 to define a first section, rear panel 1424 is spaced apart from rear panel 1444 to define a second section, first side panel 1426 is spaced apart from first side panel 1446 to define a third section, second side panel 1428 is spaced apart from second side panel 1448 to define a fourth section, and bottom panel 1420 is spaced apart from bottom panel 1440 to define a fifth section. Accordingly, the first space 146 may be defined by the first section, the second section, the third section, the fourth section, and the fifth section between the first tub 142 and the second tub 144.

In some embodiments, the first tub 142 and the second tub 144 are made of stainless steel. In some embodiments, the first tub 142 and the second tub 144 are made of a plastic (e.g., polyvinyl chloride or PVC, high-density polyethylene or HDPE, or polystyrene). In some embodiments, the first tub 142 is made of a first material and the second tub 144 is made of a second material different from the first material. It should be understood that the first tub 142 and the second tub 144 may be made from any suitable material, and that the first tub 142 and the second tub 144 may be made from the same material or different materials as applications warrant.

Each of the front panel 1422 of the first tub 142 and the front panel 1442 of the second tub may include a window. For instance, front panel 1422 may be made of a transparent material (e.g., glass, clear plastic) such that front panel 1422 defines a first window 1423. Similarly, front panel 1442 may be made of a transparent material (e.g., glass, clear plastic) such that front panel 1442 defines a second window 1443. Accordingly, a user may be able to see inside of second tub 144 through first window 1423, second window 1443, and the first section to check a level of ice within second tub 142.

The first space 146 may contain a heat transfer material 148. The heat transfer material 148 may be a material having a high thermal conductivity. For instance, the heat transfer material 148 may have a thermal conductivity higher than a thermal conductivity of air. The heat transfer material 148 may be a liquid, although any suitable material may be used. In one embodiment, the heat transfer material 148 is a food safe antifreeze. In an alternative embodiment, the heat transfer material 148 is water.

The beverage cooling system 11 may further include a tube 150 passing through the first space 146 and in thermal communication with the heat transfer material 148. The tube 150 may be configured for receiving a beverage. In detail, the tube 150 may include an inlet 152 and an outlet 154. The inlet 152 may be provided at an upper portion of the first tub 142. For example, the inlet 152 may be provided at or near the top of second side panel 1428 of first tub 142. The inlet 152 may be provided at or near the top of first side panel 1426 or rear panel 1424 of first tub 142 in some embodiments. The outlet 154 may be provided at a lower portion of the first tub 142. For example, the outlet 154 may be provided at or near the bottom of first side panel 1426 of first tub 142. The outlet 154 may be provided at or near the bottom of second side panel 1428 or rear panel 1424 of first tub 142 in some embodiments.

The tube 150 may be provided in a zig-zag shape (or serpentine path) within the first space 146. Specifically, the tube 150 may have a plurality of straight portions 156 and a plurality of curved portions 158 that connect adjacent straight portions 156 (or, collectively, serpentine tubes) to each other to form a meandering shape. For example, it may be desirable to increase thermal contact between the tube 150 and the heat transfer material 148 in order to increase heat transfer. The plurality of straight portions 156 may be provided in the second section, the third section, the fourth section, and the fifth section. The plurality of straight portions 156 may be provided in any suitable combination of sections of the first, second, third, fourth, and fifth sections, as applications warrant. In other words, the tube 150 may zig-zag around the second tub 144 along the first side panel 1446, the second side panel 1448, the rear panel 1444, and the bottom panel 1440 of the second tub 144. Specifically, in some embodiments, the plurality of straight portions 156 may not be provided in the first section when front panel 1422 and front panel 1442 are transparent.

The tube 150 may be configured for receiving a beverage (e.g., water, soda, juice, etc.) The beverage may be introduced into the tube 150 at the inlet 152. The beverage may be supplied separately by a user (for instance, in the case of soda or juice), or may be supplied directly from a source (for instance, a municipal water source). Accordingly, as the beverage flows through the tube 150 (e.g., the straight portions 156 and the curved portions 158), heat may be removed from the beverage via the heat transfer material 148 and the ice in the second tub 144. Although the beverage cooling system 11 is described herein as chilling a beverage, certain applications may utilize the system 11 to heat a beverage as well (e.g., by filling second tub 144 with a heated liquid or substance). According to such applications, heat may be transferred to the beverage circulating through tube 150 in order to produce a heated beverage (e.g., for coffee or tea).

The beverage cooling system 11 may further include a valve 160 on the tube 150 (i.e., in fluid communication with the tube 150). The valve 160 may be configured to selectively open and close the tube 150 to selectively dispense the beverage to a user. The valve 160 may be any suitable valve capable of opening and closing the tube 150, such as a solenoid valve, a manual valve, a ball valve, a push button valve, etc. The valve 160 may be provided at the outlet 154 of the tube 150. Accordingly, the valve 160 may be located at or near the bottom of the first tub 142. In some embodiments, the valve 160 may be provided at the inlet 152 of the tube 150. The valve 160 may be controlled manually by a user, or may be in electrical communication with a controller to automatically open tube 150 to dispense the beverage according to a preset program. In some embodiments, the valve 160 may be in fluid communication with dispenser nozzle 3 to allow the beverage to selectively flow to the dispenser nozzle 3.

The beverage cooling system 11 may further include an insulation layer 170 at least partially surrounding the first tub 142. The insulation layer 170 may cover the first side panel 1426, the second side panel 1428, the bottom panel 1420, and the rear panel 1424 of the first tub 142. In other words, a top of first tub 142 may be open to allow ice to enter second tub 144. Further, when front panel 1422 is a window, insulation layer 170 may not be provided on front panel 1422 so as not to obstruct a user from viewing the interior of second tub 144. The insulation layer 170 may be any suitable insulation that restricts heat transfer between the first tub 142 and an ambient atmosphere. For example, the insulation layer 170 may be a foam insulation, however, the disclosure is not limited.

The second tub 144 may include a first flange 172 protruding in a normal direction from the outer surface of the second tub 144 and extending at least partially around the outer surface of the second tub 144. The first flange 172 may protrude from the first side panel 1446, the rear panel 1444, and the second side panel 1448 of the second tub 144. In detail, when the front panel 1442 of the second tub is a window, the first flange 172 is not provided on the front panel 1442. The first flange 172 may be located a predetermined distance downward in the vertical direction V from a top of the second tub 144. In some embodiments, the first flange 172 may be located at a position about 40% of the way down the first side panel 1426 of the second tub 142 at a junction between the first side panel 1426 and the front panel 1422 of the second tub. For one example, the first flange 172 may be perpendicular to the vertical direction V.

The first flange 172 may include an inlet opening 174 in fluid communication with the first space 146 between the first tub 142 and the second tub 144. The inlet opening 174 may be a pipe that protrudes in the vertical direction V from a top surface of the first flange 172. The inlet opening 174 may be located at any suitable position on the first flange 172 that allows fluid communication with the first space 146. In some embodiments, inlet opening 174 is adjacent to a junction between the first side panel 1446 and the rear panel 1444 of the second tub 144. According to one embodiment, a user is able to add heat transfer material 148 into the first space 146 via the inlet opening 174.

In some embodiments, the first tub 142 may include a second flange 176. The second flange 176 may correspond to the first flange 172. In other words, the second flange 176 may protrude in a normal direction from the outer surface of the first tub 142. In some embodiments, the second flange 176 protrudes from the first side panel 1426, the rear panel 1424, and the second side panel 1428 of the first tub 142. When front panel 1422 if first tub 142 is a window, second flange 176 may not be provided on front panel 1422 so as not to obstruct a user's view into second tub 144. As such, in some embodiments, first flange 172 may be in planar contact with the second flange 176 when second tub 144 is nested within first tub 142.

The bottom panel 1440 of the second tub 144 may include a first outlet opening 180. The first outlet opening 180 may be provided at the first corner of the second tub 144 (i.e., the junction of the rear panel 1444, the first side panel 1446, and the bottom panel 1440). Melt water from the ice stored in second tub 144 may flow out of the second tub 144 through first outlet opening 180. Similarly, first tub 142 may include a second outlet opening 182. The second outlet opening 182 may correspond to the first outlet opening 180. In some embodiments, the first outlet opening 180 may be a pipe that extends downward in the vertical direction V from the bottom panel 1440 of the second tub 144. The pipe may then be received by the second outlet opening 182 in the first tub 142 to allow melt water to easily flow out of the second tub 144. Additionally or alternatively, the pipe may assist in locating the second tub 144 within the first tub 142 during assembly, ensuring a proper fit.

The first tub 142 may further include a drain outlet 184. The drain outlet 184 may be separate from the second outlet opening 182, and may be in fluid communication with the first space 146. Fluid provided in the first space 146 may be drained from the first space 146 via the drain outlet 184.

FIG. 11 provides a schematic view of a recirculation system. The appliance 10 may further include a recirculation system 190 for recirculating melt water from the second tub 144 to the ice maker 50. Recirculation system 190 may include a recirculation line 192 having a first end fluidly connected to the first outlet opening 180 of the second tub 144. In detail, one of the first end of the recirculation line 192 and the first outlet opening 180 of the second tub 144 may pass through the second outlet opening 182 of the first tub 142. Thus, melt water from the second tub 144 may flow directly into recirculation line 192 without mixing with first space 146. The recirculation system 190 may further include the filter 194 which may be in fluid communication with the recirculation line 192. The melt water from the second tub 144 may pass through the filter 194 to filter out impurities before being cycled back into ice maker 50. The filter 194 may be any suitable filter capable of providing clean, potable water, such as a carbon-based filter, for example. The amount and type of filter is not limited in this disclosure, and it is understood that any appropriate combination can be used. The recirculation system 190 may further include a pump 196 for pumping the melt water through the filter 194 and into the ice maker 50. The pump 196 may be in fluid communication with the recirculation line 192. The pump 196 may be any suitable pump capable of pumping the melt water from the first outlet opening 180 to the ice maker 50. In some embodiments, the recirculation system 190 may circulate the melt water from second tub 144 up to reservoir 34 (FIG. 3), for example, when beverage cooling system 11 is combined with ice making appliance 10.

Hereinafter, an alternate embodiment of the present system 11 will be discussed. Like reference numerals refer to like features, and detailed description of identical features will be omitted for brevity. In an alternate embodiment of the present disclosure, the tube 150 may be omitted. Specifically, the second tub 144 may be nested within the first tub 142 to form the first space 146. However, the tube 150 may not be provided within the first space 146. Instead, the first space 146 may be configured to store the beverage to be dispensed directly to a user. In this manner, the beverage would exchange heat with the second tub 144 and the ice stored within second tub 144 to be cooled to a desired temperature.

According to this embodiment, the valve 160 may be in fluid communication with the drain outlet 184 to selectively open and close the drain outlet 184 to release the beverage from the first space 146. Further, the inlet opening 174 in the first flange 172 of the second tub may allow the beverage to be introduced into the first space 146. The inlet opening 174 may be a pipe that extends upward in the vertical direction V from the first flange 172, and may be connected directly to a beverage source (e.g., a municipal water source). Alternatively, the pipe may be open to the ambient atmosphere to allow a beverage to be introduced to the first space 146 by a user.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A beverage cooling system, comprising:
a first tub, the first tub comprising a bottom panel, wherein an outlet opening is formed through the bottom panel of the first tub;
a second tub nested within the first tub to define a first space therebetween for receiving a heat transfer material, wherein the first space is fluidly isolated from the second tub, and wherein the second tub comprises a bottom panel, the bottom panel comprising an outlet pipe extending downward along the vertical direction; and
a tube passing through the first space and being in thermal communication with the heat transfer material, wherein the tube is configured for receiving a beverage, wherein the outlet pipe extends through the outlet opening to allow fluid from the second tub to be drained.

2. The beverage cooling system of claim 1, wherein an inlet to the tube is provided at an upper portion of the first tub and an outlet of the tube is provided at a lower portion of the first tub, and wherein the tube zig-zags around the second tub along a first side, a second side, a rear side, and a bottom of the second tub.

3. The beverage cooling system of claim 2, further comprising a dispenser valve in fluid connection with the tube for selectively opening and closing the tube, wherein the dispenser valve is provided at the outlet of the tube.

4. The beverage cooling system of claim 1, wherein the second tub is made of stainless steel and is configured for storing ice.

5. The beverage cooling system of claim 1, further comprising an insulation layer at least partially surrounding the first tub.

6. The beverage cooling system of claim 1, wherein the second tub comprises a flange protruding perpendicularly from an outer surface of the second tub and extending at least partially around the outer surface of the second tub.

7. The beverage cooling system of claim 6, wherein the flange includes an inlet opening in fluid communication with the first space between the first tub and the second tub.

8. The beverage cooling system of claim 1, wherein a bottom panel of the second tub is inclined with respect to a horizontal plane from a rear edge of the second tub to a front edge of the second tub such that the rear edge is lower than the front edge, and wherein the outlet pipe is provided at the rear edge of the bottom panel.

9. The beverage cooling system of claim 8, wherein the bottom panel of the second tub is inclined with respect to the horizontal plane from a first side edge of the second tub to a second side edge of the second tub such that the first side edge is lower than the second side edge, and wherein the outlet pipe is provided at a junction of the first side edge and the rear edge of the bottom panel.

10. The beverage cooling system of claim 9, further comprising an ice maker adjacent to the second tub, the ice maker producing ice to be transferred to the second tub for storage.

11. The beverage cooling system of claim 10, further comprising a recirculation system, the recirculation system comprising:
a recirculation line having a first end fluidly connected to the outlet pipe of the second tub and a second end fluidly connected to the ice maker;
a filter in fluid communication with the recirculation line; and
a recirculation pump in fluid communication with the recirculation line, the recirculation pump configured to pump melt water from the second tub to the ice maker.

12. The beverage cooling system of claim 1, wherein the heat transfer material is water.

13. The beverage cooling system of claim 1, wherein the heat transfer material is antifreeze.

14. The beverage cooling system of claim 1, wherein the beverage is potable water.

15. The beverage cooling system of claim 1, wherein the first tub includes a first window and the second tub includes a second window, and wherein the first window and the second window overlap such that an interior of the second tub is visible from an outside of the first tub.

16. A beverage cooling system, comprising:
a first tub configured to store a quantity of ice, wherein the first tub includes a drain outlet provided in a bottom panel of the first tub, the drain outlet being in fluid communication with the first space;
a second tub nested within the first tub to define a first space between the first tub and the second tub, the first space being fluidly isolated from the second tub;
an ice maker for forming the quantity of ice and providing the ice into the second tub; and
a recirculation system in fluid communication with the second tub, the recirculation system comprising:
a recirculation line having a first end fluidly connected to an outlet pipe of the second tub and a second end fluidly connected to the ice maker;
a filter in fluid communication with the recirculation line; and
a recirculation pump in fluid communication with the recirculation line, the recirculation pump configured to pump melt water from the second tub to the ice maker.

17. The beverage cooling system of claim 16, wherein the beverage cooling system further comprises:
a heat transfer material positioned within the first space; and
a tube passing through the first space and being in thermal communication with the heat transfer material, wherein the tube is configured for receiving a beverage.

18. The beverage cooling system of claim 16, wherein the first space is configured for receiving a beverage.

19. (canceled)

20. The beverage cooling system of claim 16, further comprising a valve provided at the outlet opening, the valve being configured to selectively open and close the outlet opening to dispense the beverage from the first space.

21. The beverage cooling system of claim 16, wherein the first tub further includes an outlet opening provided in the bottom panel of the first tub, the outlet opening being in fluid communication with the second tub, wherein the outlet opening is separate from the drain outlet.
